(19) United States
(12) Patent Application Publication
(10) Pub. No.: US 2025/0361120 A1
(43) Pub. Date: Nov. 27, 2025

(54) MAIN SHAFT LIFTING TOOL

(71) Applicant: LiftWerx Solutions Inc., Cambridge (CA)

(72) Inventors: Glen D. AITKEN, Guelph (CA); Peter Staun CORNELISSE, Kitchener (CA)

(73) Assignee: LiftWerx Solutions Inc., Cambridge, ON (CA)

(21) Appl. No.: 18/874,329

(22) PCT Filed: Jul. 12, 2023
(86) PCT No.: PCT/CA2023/050933

§ 371 Date: Dec. 12, 2024

Related U.S. Application Data
(60) Provisional application No. 63/390,009, filed on Jul. 18, 2022.

(51) Int. Cl. B66C 1/10; B66C 23/20; F03D 13/10; F03D 80/50

(52) U.S. Cl. CPC B66C 1/108; B66C 23/207; F03D 13/139; F03D 80/504; F05B 2230/61; F05B 2230/70; F05B 2240/60

(57) ABSTRACT

A tool for lifting a main shaft of a wind turbine has a rail having a first end and a second end, the rail configured to be fixedly mounted proximate the first end of the rail to the main shaft proximate a rotor hub mounting end of the main shaft. A counterweight is movably mounted on the rail to permit moving the counterweight longitudinally along the rail. A lug is fixedly mounted on the rail proximate the first end of the rail, the lug configured to be securable to a lifting device so that the rail can be suspended from the lifting device. Use of a counterweighted lifting tool such as the one described above permits mounting and dismounting the main shaft underneath a nacelle-mounted lift system.

### CROSS-REFERENCE TO RELATED APPLICATIONS

This application claims the benefit of United States Provisional Application USSN 63/390,009 filed Jul. 18, 2022, the entire contents of which is herein incorporated by reference.

### FIELD

This application relates to wind turbines, in particular to a tool for lifting a main shaft of a wind turbine and methods of using the tool to lift the main shaft of the wind turbine.

### BACKGROUND

Mounting and dismounting a main shaft of a wind turbine from an up-tower nacelle of the wind turbine presents a number of challenges due to the weight of the main shaft, the height of the nacelle above the ground and the non-zero (e.g., 4°) inclined angle of a longitudinal axis of the main shaft with respect to the horizontal when the main shaft is properly mounted in the nacelle. Typically, a large ground-based lifting device or a smaller up-tower nacelle-mounted lifting device is employed to lift the main shaft into or out of the nacelle. The hoist (e.g., hook) of the lifting device is typically connected to the main shaft over the center-of-gravity of the main shaft so that the main shaft is balanced and can be lifted and carried generally parallel to the ground.

However, there are situations in which the hoist cannot be connected directly over the center-of-gravity of the main shaft, for example when an up-tower lifting device is mounted in the nacelle over the main shaft at a location that obstructs access of the hoist to a position over the center-of-gravity of the main shaft. In addition, the main shaft must be mounted in the nacelle at a non-zero angle with respect to the horizontal, therefore, any tool used to mount/dismount the main shaft preferably has the ability to adjust the angle of the main shaft with respect to the horizontal.

There remains a need for a main shaft lifting tool that can be used to mount and dismount a main shaft of a wind turbine in a nacelle when a hoist is unable to be connected to the main shaft over the center-of-gravity of the main shaft.

### SUMMARY

A tool for lifting a main shaft of a wind turbine comprises: a rail having a first end and a second end, the rail configured to be fixedly mounted proximate the first end of the rail to the main shaft proximate a rotor hub mounting end of the main shaft; a counterweight movably mounted on the rail to permit moving the counterweight longitudinally along the rail; and, a lug fixedly mounted on the rail proximate the first end of the rail, the lug configured to be securable to a lifting device so that the rail can be suspended from the lifting device.

A method of dismounting a main shaft from a nacelle of a wind turbine comprises: removing a rotor hub from the main shaft; using a lifting device to lift a counterweighted lifting tool to the main shaft; connecting the lifting tool to the main shaft; moving a counterweight on the lifting tool to adjust a center of gravity of the connected counterweight and main shaft to a position beneath the lifting device; and, operating the lifting device to move the lifting tool with the main shaft connected thereto to dismount the main shaft from the nacelle.

A method of mounting a main shaft in a nacelle of a wind turbine comprises: operating a lifting device connected to a counterweighted lifting tool, the lifting tool having the main shaft connected thereto, to move the lifting tool so that the main shaft is inserted into the nacelle; moving a counterweight on the lifting tool to change an angle of the main shaft so that the main shaft is properly angled for mounting in the nacelle; operating the lifting device to move the lifting tool to mount the main shaft in the nacelle; and, disconnecting the lifting tool from the main shaft.

Use of a counterweighted lifting tool, such as the one described above, permits mounting and dismounting a main shaft of a wind turbine, especially underneath a nacelle-mounted lift system. The lifting tool permits installation and deinstallation of the main shaft under circumstances where a hoist of the lifting device cannot be connected over the center-of-gravity of the main shaft. The lifting tool can be angled by adjusting the counterweight on the lifting tool to accommodate the angle of the main shaft during connection of the lifting tool to the main shaft and during disconnection of the lifting tool from the main shaft. The counterweight on the lifting tool can also be adjusted to maintain the non-zero inclined angle of the main shaft when the tool is used to help withdraw the main shaft from the nacelle and insert the main shaft into the nacelle.

The lifting tool preferably comprises a rail having a longitudinal first end and a longitudinal second end. In some embodiments, a carriage is movably mounted on the rail to be movable longitudinally on the rail. In some embodiments, a counterweight is secured to the carriage. The carriage is movably mounted on the rail in any suitable manner, for example, the carriage may comprise at least one roller, preferably a plurality of rollers, for example four rollers, that rest on an upper surface of the rail to suspend the carriage from the rail, and which permit the carriage to translate longitudinally on the rail. The carriage may further comprise transversely oriented opposed retaining plates extending downwardly from the carriage beneath the rail between which the counterweight is secured to the carriage, preferably beneath the rail. The counterweight may be secured between the retaining plates by any suitable means, for example pins, clamps, clips and the like. In some embodiments, the counterweight is secured by at least one pin, preferably a plurality of pins, for example two pins, inserted through aligned apertures in the retaining plates and the counterweight. With the counterweight secured between the retaining plates, translation of the carriage on the rail causes the counterweight to also translate longitudinally along the rail to thereby change longitudinal position of the counterweight on the rail thus changing the location of the center-of-gravity of the rail. The counterweight may comprise one monolithic piece or may comprise a plurality of individual pieces, preferably in the form of slabs. The individual pieces may have apertures aligned with the apertures on adjacent pieces through which pins are inserted to secure all the individual pieces to the retaining plates. One or more of the individual pieces may be removed or replaced with smaller pieces when a less heavy counterweight is desired. One or more the pieces may be replaced by larger pieces when a heavier counterweight is desired.

The tool may further comprise a carriage drive configured to translate the carriage longitudinally on the rail. Any suitable carriage drive may be used. In some embodiments, the carriage drive comprises a threaded rod mated with a an internally threaded guide cylinder whereby rotation of the threaded rod causes translation of the threaded guide cylinder on the threaded rod. Mounting the counterweight to the guide cylinder then permits translation of the counterweight longitudinally along the rail by rotating the threaded rod. The threaded rod may be rotatably mounted in bearing blocks. The bearing blocks may be connected to rod mounts that are mounted on and extend upwardly from the rail thereby situating the threaded rod above the rail. The threaded rod preferably extends longitudinally parallel to the rail between the first end and the second end of the rail. The carriage drive may further comprise a bracket connected to and extending upwardly from the carriage. The bracket 35 may be attached to the internally threaded guide cylinder through which the threaded rod 31 is mated and rotatably mounted. The threaded rod may be rotatable within the guide cylinder to translate the guide cylinder and therefore the carriage longitudinally on the rail when the threaded rod rotates. Due to the mated threads between the threaded rod and the threaded guide cylinder, rotational motion of the threaded rod, which is otherwise fixedly connected to the rail, causes translational motion of the guide cylinder, and therefore the carriage and the counterweight, longitudinally along the rail. The direction of translation of the guide cylinder depends on the direction of rotation of the threaded rod. The threaded rod may be rotationally driven by any suitable means, for example a hand crank, a motor or the like, operatively coupled to the threaded rod. In some embodiments, a drive shaft of a motor (e.g., electric or hydraulic motor) may be operatively connected to a motor drive shaft connection sleeve on an end of the threaded rod. Preferably, the second end of the rail comprises a motor mount for mounting the motor on the tool. In some embodiments, the motor may be a hand-held motor, preferably operatively connected to the end of the threaded rod at the first end of the rail. In other embodiments, the motor may be remotely operable by remote control.

Preferably, the rail is configured to be fixedly mounted proximate the first end of the rail to a main shaft of the wind turbine proximate a rotor hub mounting end of the main shaft. In some embodiments, the rail may comprise an abutment plate at the first end of the rail. The abutment plate may be welded to or integrally formed with the rail. The abutment plate may comprise at least one fastener, preferably a plurality of fasteners, for example two fasteners extending longitudinally therefrom. The at least one fastener may be aligned with at least one flange aperture, preferably a plurality of flange apertures, for example two flange apertures, in the rotor hub flange for insertion of the at least one fastener through the at least one flange aperture to permit fixedly mounting the rail to the rotor hub flange. In some embodiments, the abutment plate may comprise a face configured to abut a face of the rotor hub flange of the main shaft. The fasteners are preferably bolts with nuts, but can be any suitable fastener, for example clips, pins other than bolts and the like may be used. In some embodiments, least one indexing pin, preferably a plurality of indexing pins, for example two indexing pins, may be used to assist with aligning the at least one fastener with the at least one flange aperture. The at least one indexing pin may align with at least one different flange aperture than is aligned with the at least one fastener.

In some embodiments, the tool may further comprise a lug pivotally secured to, and preferably upwardly extending from, the upper surface of the rail proximate the first end of the rail. The lug may be configured to be securable to a lifting device so that the rail can be suspended from the lifting device. The lug is preferably pivotally connected to the rail at a pivot point, preferably through a pivot pin. The lug is preferably mounted on a gusset, preferably through the pivot pin. The gusset 51 may be welded to or integrally formed with the rail. The gusset may also be welded to or integrally formed with the abutment plate. The lug situates the pivot point at the pivot pin where the tool is suspended from the lifting device. The counterweight comprises a center-of-gravity, and the counterweight is moveable proximally (toward the first end) on the rail so that the center-of-gravity of the counterweight is between the first end of the rail and a vertical axis through the pivot point so that the first end of the rail is tipped downwardly to permit connecting the rail to rotor hub flange of the main shaft when the main shaft is mounted in the wind turbine. In some embodiments, to further facilitate connecting the rail to the rotor hub flange, the face of the abutment plate is angled downward (for example by 4°) with respect to a longitudinal axis of the rail so that the longitudinal axis of the rail can be parallel to the ground when the abutment plate is in the proper orientation for the tool to be connected to the main shaft.

In an embodiment of the method for dismounting the main shaft from the nacelle of the wind turbine, a rotor of the wind turbine is disconnected from the main shaft and a lifting device is used to lower the rotor (hub and blades) to the ground. The lifting device may be a ground- based crane, a nacelle-mounted lift system or any other lift system, but is preferably a nacelle- mounted lift system. After lowering the rotor to the ground, the main shaft lifting tool is connected to the lifting device and raised up toward the nacelle. The counterweight is situated proximate the first end of the rail so that the center-of-gravity of the tool is situated appropriately so that the rail is substantially parallel to the ground. The lifting device is then operated to bring the main shaft lifting tool to the rotor hub flange where the lifting tool is then connected to the rotor hub flange. In some embodiments, the face of the abutment plate abuts the face of the rotor hub flange, and with the aid of the indexing pins, which engage corresponding flange apertures in the rotor hub flange, the main shaft lifting tool is positioned so that the fasteners can be inserted through their own corresponding flange apertures. The fasteners are then secured to prevent the fasteners from slipping out of their corresponding flange apertures.

With the main shaft lifting tool secured to the rotor hub flange, and therefore to the main shaft, the counterweight on the lifting tool may be moved from the first end closer to the second end of the rail so that the center-of-gravity of the combined lifting tool and main shaft remains at an appropriate position so that the angle of inclination of the main shaft relative to the ground (e.g., 4°) is maintained when the lifting tool is suspended from the lifting device. Having attached the main shaft lifting tool to the main shaft and moved the counterweight to adjust the center-of-gravity of the combined lifting tool and main shaft, the lifting device is operated to move the lifting tool away from the nacelle thereby removing the main shaft from the nacelle. The lifting tool with the dismounted main shaft attached thereto can be lowered to the ground while maintaining the main shaft at the same non-zero (e.g., 4°) angle it was in when mounted in the nacelle. If necessary, the position of the counterweight can be adjusted on the rail to pivot the combined lifting tool and main shaft about the pivot point to make the main shaft parallel to the ground.

Mounting the main shaft in the nacelle can be accomplished by reversing the steps described above.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a perspective view of a main shaft lifting tool with a counterweight positioned at a first end of the tool.

FIG. 2A depicts a magnified view of the first end of the tool of FIG. 1.

FIG. 2B depicts a side view of FIG. 2A.

FIG. 3 depicts the tool of FIG. 1 with the counterweight positioned proximate a second end of the tool.

FIG. 4 depicts a magnified view of the second end of the tool of FIG. 3.

FIG. 5 depicts a side view of the tool of FIG. 3.

FIG. 6 depicts a step in a method for dismounting a main shaft of a wind turbine in which a rotor with rotor blades is being lowered to the ground by a nacelle-mounted lift system from a nacelle atop a tower of the wind turbine.

FIG. 7 depicts a step in the method for dismounting the main shaft in which the main shaft lifting tool of FIG. 1 is being lifted up to the nacelle by the nacelle-mounted lift system.

FIG. 8A depicts a step in the method for dismounting the main shaft in which the main shaft lifting tool is connected to a rotor hub mounting end of the main shaft.

FIG. 8B depicts a view of the main shaft lifting tool in FIG. 8A connected to the main shaft without showing the lift system.

FIG. 8C depicts a magnified view of FIG. 8B.

FIG. 8D depicts a magnified rear perspective view of the main shaft lifting tool of FIG. 8A connected to the main shaft without showing the nacelle.

FIG. 9A depicts a step in the method for dismounting the main shaft in which the counterweight has been moved from the first end of the main shaft lifting tool to a position proximate the second end of the main shaft lifting tool to change the angle of the lifting tool so that the main shaft is parallel to the ground.

FIG. 9B depicts an alternate perspective view of FIG. 9A without showing the lift system.

FIG. 10A depicts a step in the method for dismounting the main shaft in which the main shaft connected to lifting tool is dismounted from the nacelle by operation of the lift system.

FIG. 10B depicts a perspective view of the main shaft connected to lifting tool.

FIG. 10C depicts an alternate perspective view of the main shaft connected to lifting tool.

### DETAILED DESCRIPTION

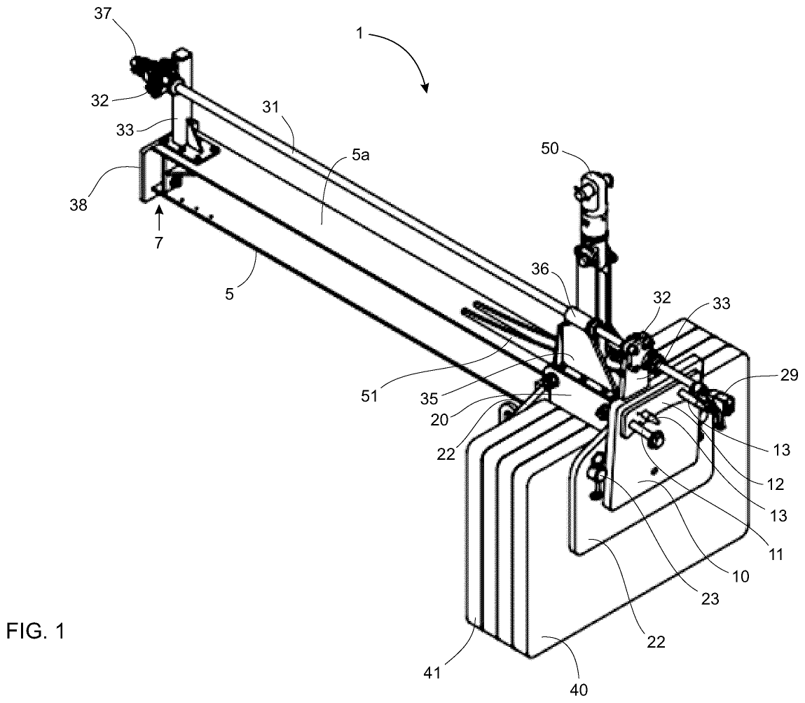

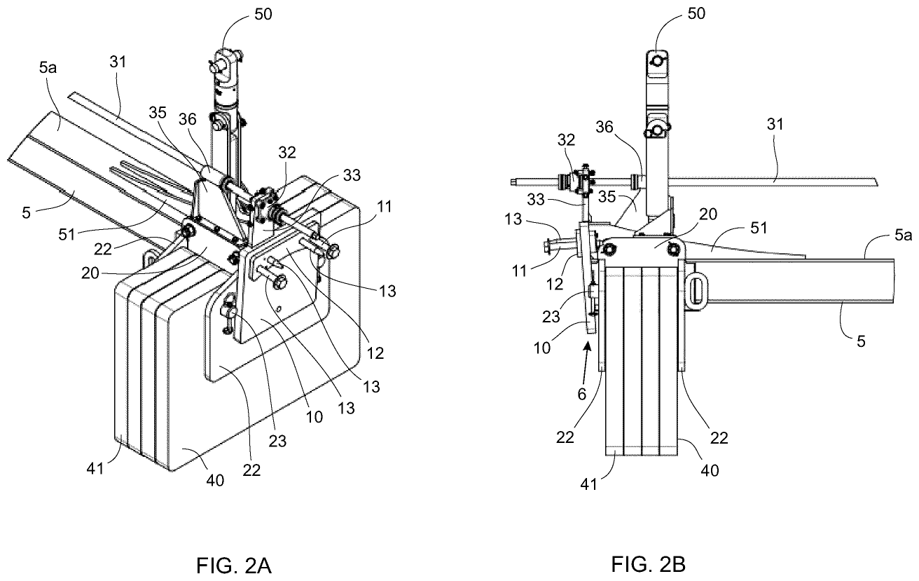

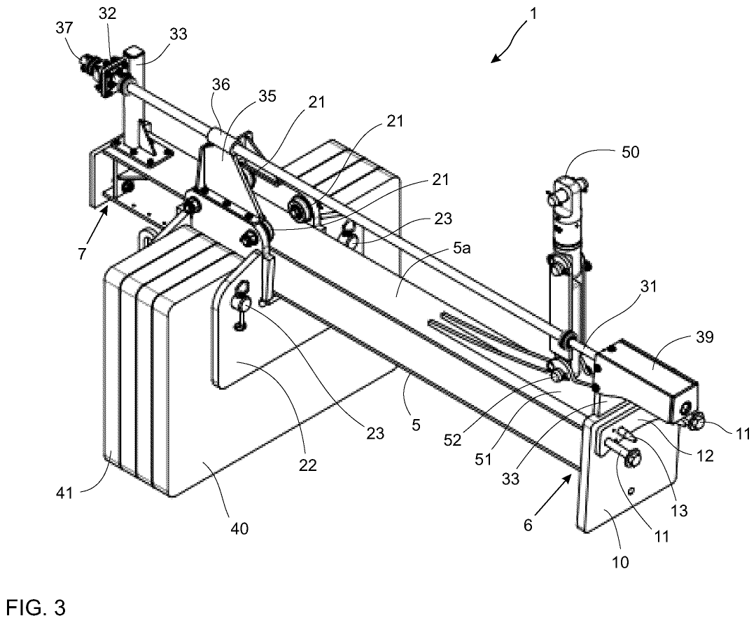

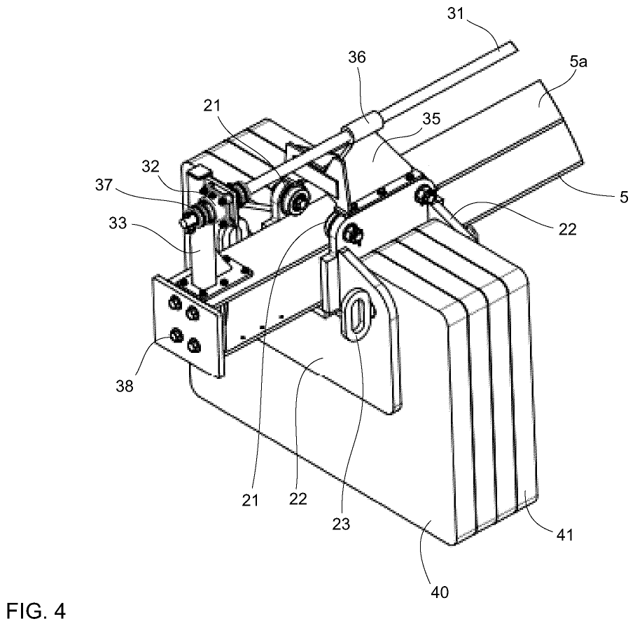

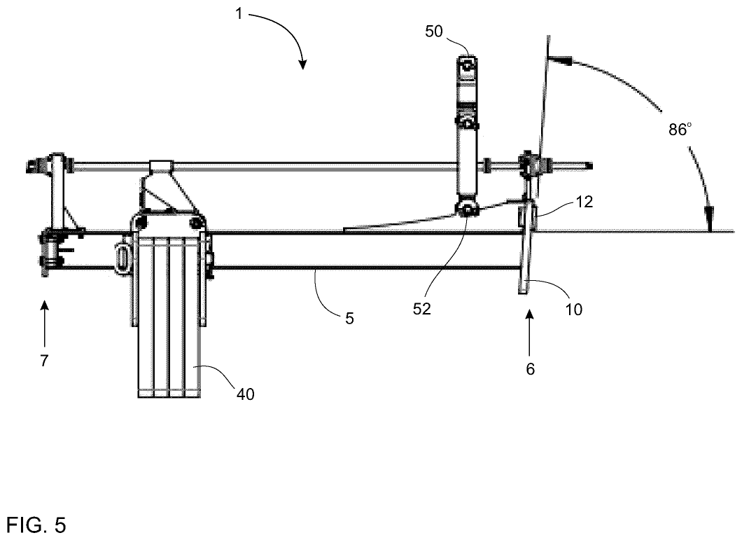

With reference to FIG. 1 to FIG. 5, a counterweighted main shaft lifting tool 1 comprises a rail 5, having a longitudinal first end 6 and a longitudinal second end 7, a carriage 20 movably mounted on the rail 5, and a counterweight 40 secured to the carriage 20. The carriage 20 comprises at least one roller, preferably a plurality of rollers, for example four rollers 21, that rest on an upper surface 5a of the rail 5 to suspend the carriage 20 from the rail 5, and which permit the carriage 20 to translate longitudinally on the rail 5. The carriage 20 further comprises transversely oriented opposed retaining plates 22 extending downwardly from the carriage 20 beneath the rail 5 between which the counterweight 40 is secured to the carriage 20 beneath the rail 5. The counterweight 40 is secured between the retaining plates 22 by at least one pin, preferably a plurality of pins, for example two pins 23, inserted through aligned apertures in the retaining plates 22 and the counterweight 40. With the counterweight 40 secured between the retaining plates 22, translation of the carriage 20 on the rail 5 causes the counterweight 40 to also translate longitudinally along the rail 5 to thereby change longitudinal position of the counterweight 40 on the rail 5 thus changing the location of the center-of-gravity of the rail 5. The counterweight 40 preferably comprises a plurality of individual slabs 41, only one of four labeled, which have apertures aligned with the apertures on adjacent slabs through which the pins 23 are inserted. One or more of the slabs 41 may be removed or replaced with smaller slabs when a less heavy counterweight 40 is desired. One or more the slabs 41 may be replaced by larger slabs when a heavier counterweight 40 is desired.

The tool 1 further comprises a carriage drive configured to translate the carriage 20 longitudinally on the rail 5. The carriage drive comprises a threaded rod 31 rotatably mounted in bearing blocks 32, the bearing blocks 32 connected to rod mounts 33 that are mounted on and extend upwardly from the rail 5 thereby situating the threaded rod 31 above the rail 5. The bearing blocks 32, and the motor 29, may be protected by covers 39 (only one shown). The threaded rod 31 extends longitudinally parallel to the rail 5 between the first end 6 and the second end 7 of the rail 5. The carriage drive further comprises a bracket 35 connected to and extending upwardly from the carriage 20, the bracket 35 attached to an internally threaded guide cylinder 36 mounted thereto through which the threaded rod 31 is mated and rotatably mounted. The threaded rod 31 is rotatable within the guide cylinder 36 to translate the guide cylinder 36 and therefore the carriage 20 longitudinally on the rail 5 when the threaded rod 31 rotates. Due to the mated threads between the threaded rod 31 and the threaded guide cylinder 36, rotational motion of the threaded rod 31, which is otherwise fixedly connected to the rail 5, causes translational motion of the guide cylinder 36, and therefore the carriage 20 and the counterweight 40, longitudinally along the rail 5. The direction of translation of the guide cylinder 36 depends on the direction of rotation of the threaded rod 31. The threaded rod 31 may be rotationally driven by a motor (not shown) operatively coupled to a motor drive shaft connection sleeve 37 on an end of the threaded rod 31. The second end 7 of the rail 5 comprises a motor mount 38 for mounting the motor on the tool 1. Alternatively or additionally, and as shown in FIG. 1, a hand-held motor 29 may be used, which is operatively connected to an end of the threaded rod at the first end 6 of the rail 5 so that the hand-held motor 29 may be operated by a user standing in the nacelle 101.

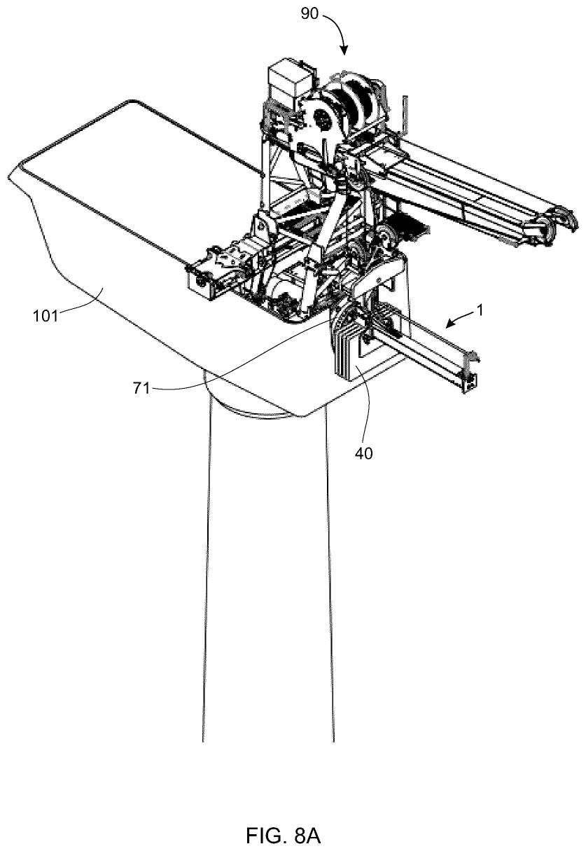

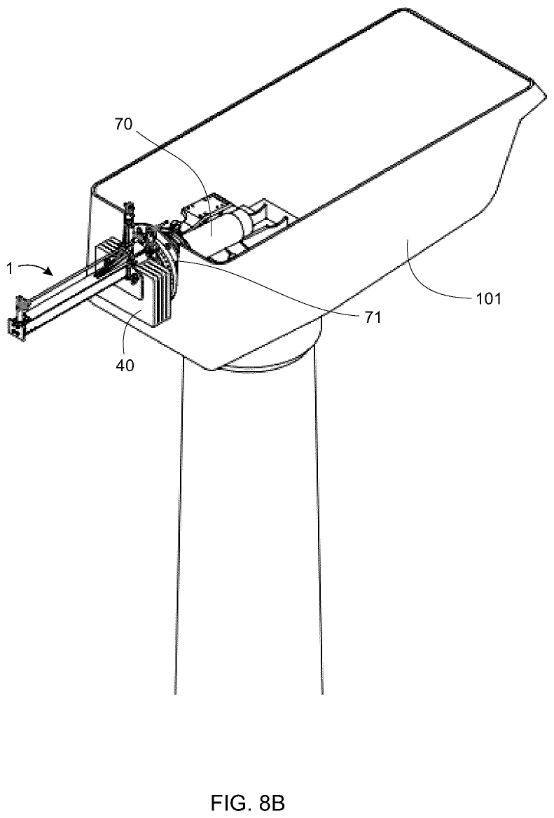

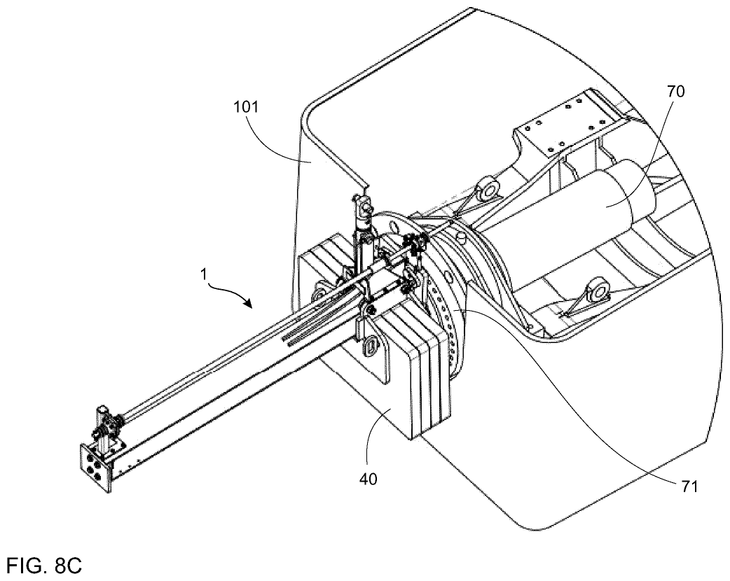

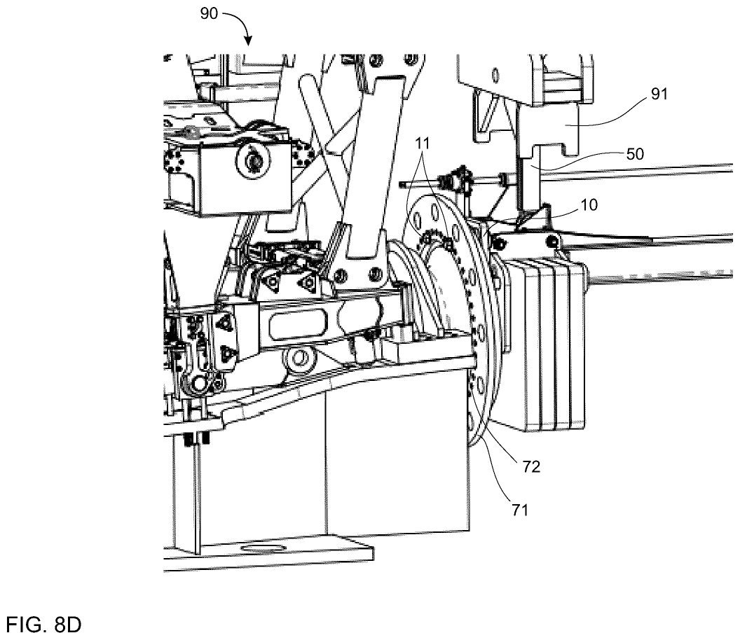

The rail 5 is configured to be fixedly mounted proximate the first end 6 of the rail 5 to a main shaft 70 (see FIG. 8C) of the wind turbine proximate a rotor hub mounting end of the main shaft 70. To this end, the rail 5 comprises an abutment plate 10 at the first end 6 of the rail 5.

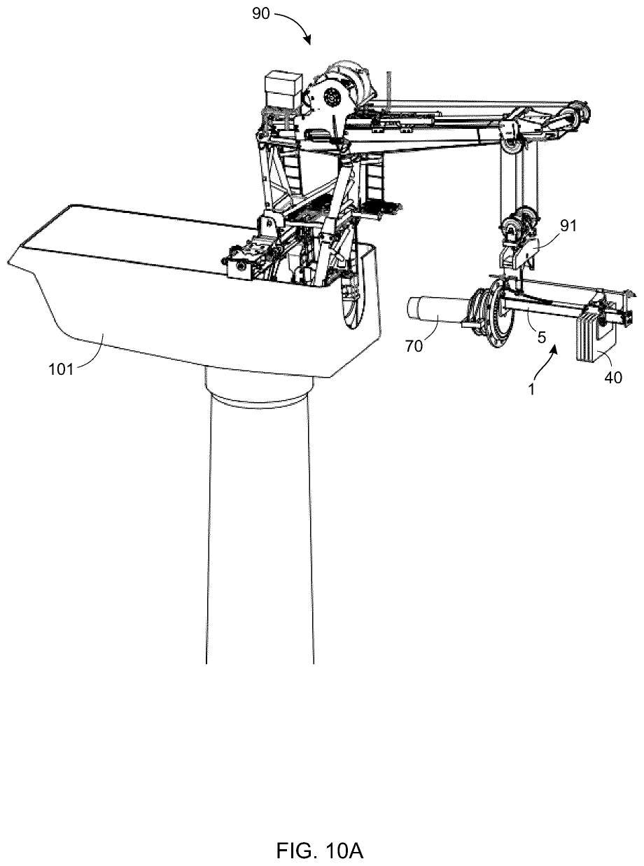

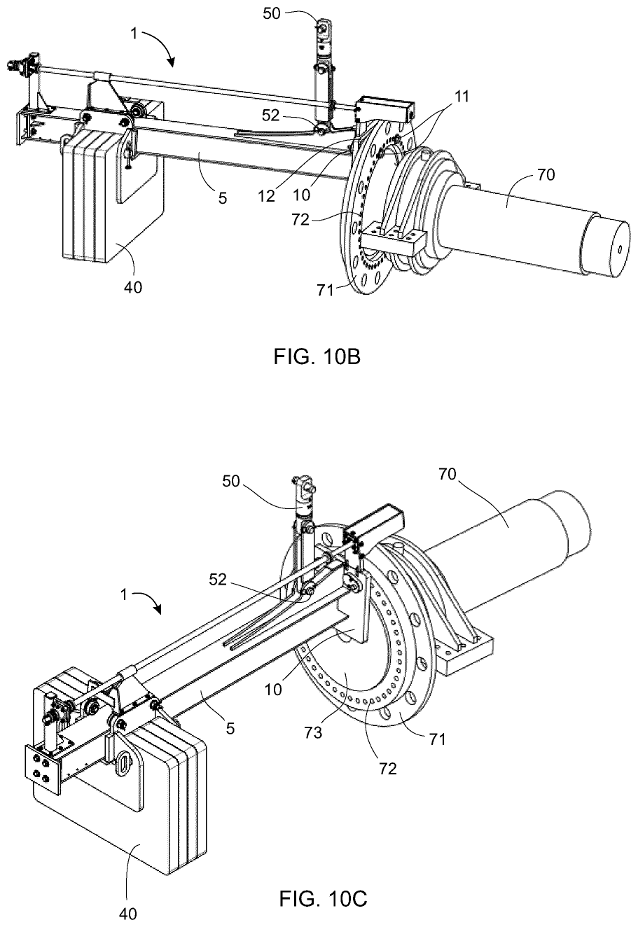

The abutment plate 10 may be welded to or integrally formed with the rail 5. The abutment plate 10 comprises at least one fastener 11, preferably a plurality of fasteners, for example two fasteners (identified in Figures) extending longitudinally therefrom, the at least one fastener aligned with at least one flange aperture 72 (an unused one is identified in FIG. 8D), preferably a plurality of flange apertures, for example two flange apertures, in the rotor hub flange 71 (see FIG. 8D) for insertion of the at least one fastener 11 through the at least one flange aperture 72 to permit fixedly mounting the rail 5 to the rotor hub flange 71. The abutment plate 10 comprises a face 12 configured to abut a face 73 of a rotor hub flange 71 of the main shaft 70 (see FIG. 10C). The fasteners 11 are shown in the Figures as bolts with nuts, but can be any suitable fastener, for example clips, pins other than bolts and the like. The abutment plate 10 further comprises at least one indexing pin 13, preferably a plurality of indexing pins, for example two indexing pins, extending longitudinally therefrom to assist with aligning the at least one fastener 11 with the at least one flange aperture 72. The at least one indexing pin 13 aligns with at least one different flange aperture 72 than is aligned with the at least one fastener 11.

The tool 1 further comprises a lug 50 pivotally secured to, and upwardly extending from, the upper surface 5a of the rail 5 proximate the first end 6 of the rail 5. The lug 50 is configured to be securable to a lifting device so that the rail 5 can be suspended from the lifting device. The lug 50 is pivotally connected to the rail 5 through a pivot pin 52 mounted on a gusset 51. The gusset 51 is welded to or integrally formed with the rail 5. The gusset 51 may also be welded to or integrally formed with the abutment plate 10.

The lug 50 situates a pivot point at the pivot pin 52 where the tool 1 is suspended from the lifting device. The counterweight 40 comprises a center-of-gravity, and the counterweight 40 is moveable proximally (toward the first end 6) on the rail 5 so that the center-of-gravity of the counterweight 40 is between the first end 6 of the rail 5 and a vertical axis through the pivot point so that the first end 6 of the rail 5 is tipped downwardly to permit connecting the rail 5 to rotor hub flange 71 of the main shaft 70 when the main shaft 70 is mounted in the wind turbine. To further facilitate connecting the rail 5 to the rotor hub flange 71, the face 12 of the abutment plate 10 is angled downward (for example by 4°) with respect to a longitudinal axis of the rail 5 so that the longitudinal axis of the rail 5 can be parallel to the ground when the abutment plate 10 is in the proper orientation for the tool 1 to be connected to the main shaft 70.

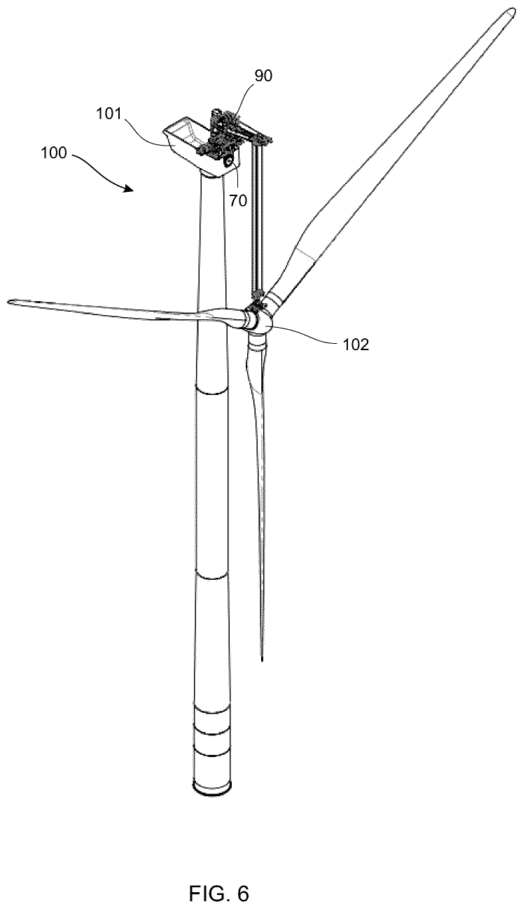

With reference to FIG. 6 to FIG. 10C, an embodiment of a method for dismounting the main shaft 70 from a nacelle 101 of a wind turbine 100 is illustrated. To mount the main shaft 70 in the nacelle 101, a reverse of the steps as described below can be followed.

To dismount the main shaft 70 from the nacelle 101, a rotor 102 of the wind turbine 100 is disconnected from the main shaft 70 and a lift system 90 mounted in the nacelle 101 over the main shaft 70 is used to lower the rotor 102 (hub and blades) to the ground, as shown in FIG. 6. The lift system 90 is preferably the one described in United States Patent Publication US 2021/0047155 published Feb. 18, 2021, the entire contents of which is herein incorporated by reference.

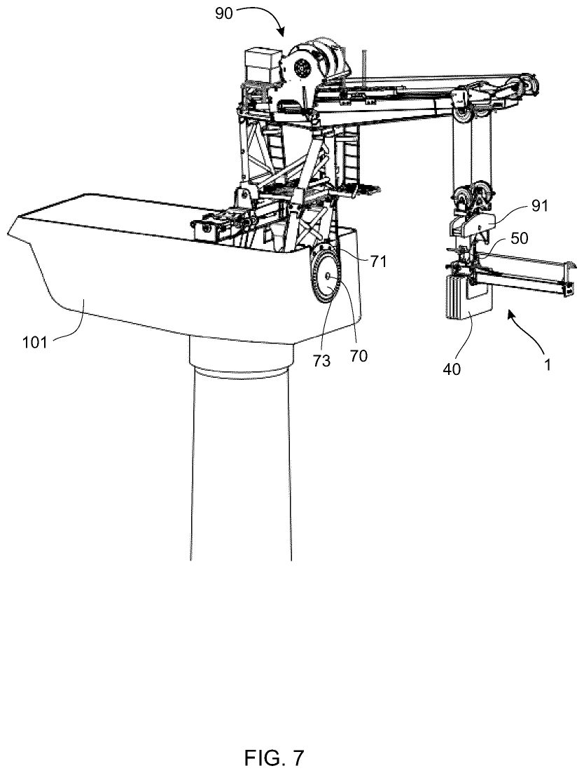

After lowering the rotor 102 to the ground, the main shaft lifting tool 1 is connected at the lug 50 to a hoist 91 of the lift system 90 and raised up toward the nacelle 101 (see FIG. 7). The counterweight 40 is situated proximate the first end 6 of the rail 5 so that the center-of-gravity of the tool 1 is situated at the lug 50 and the rail 5 is substantially parallel to the ground.

The lift system 90 is then operated to bring the main shaft lifting tool 1 to the rotor hub flange 71 where the face 12 of the abutment plate 10 abuts the face 73 of the rotor hub flange 71. With the aid of the indexing pins 13, which engage corresponding flange apertures 72 in the rotor hub flange 71, the main shaft lifting tool 1 is positioned so that the fasteners 11 (e.g., bolts) can be inserted through their own corresponding flange apertures 72, at which time the fasteners 11 are secured, for example by nuts for the bolts) to prevent the fasteners 11 from slipping out of their corresponding flange apertures 72. FIG. 8A, FIG. 8B, FIG. 8C and FIG. 8D illustrate the state achieved.

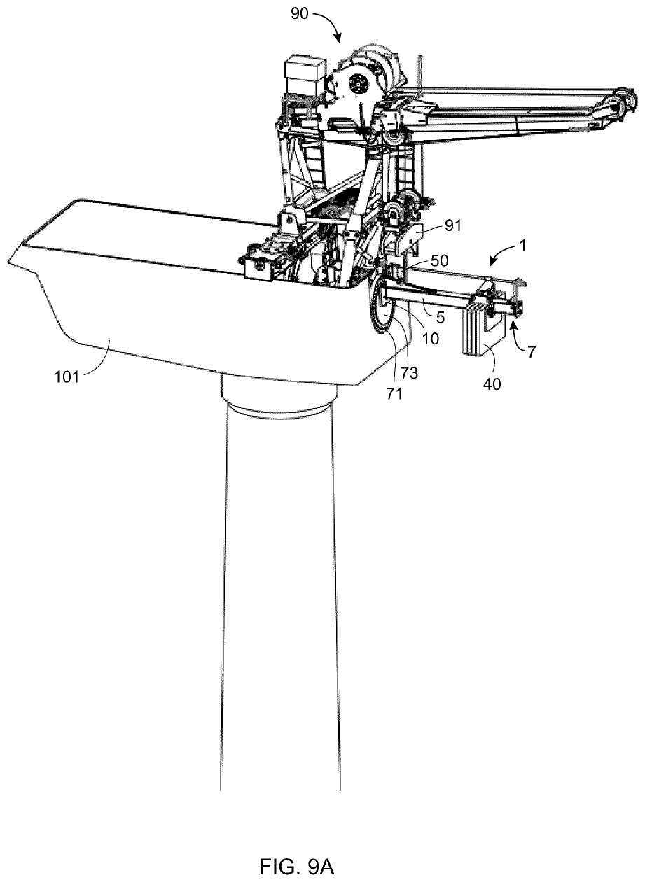

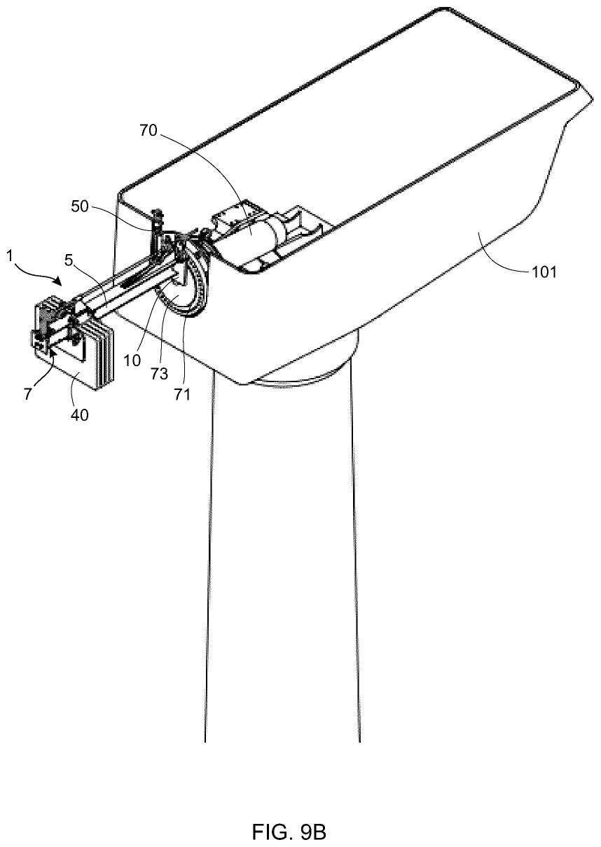

With reference to FIG. 9A and FIG. 9B, with the main shaft lifting tool 1 secured to the rotor hub flange 71, and therefore to the main shaft 70, the counterweight 40 on the lifting tool 1 is moved from the first end 6 closer to the second end 7 of the rail 5 so that the center-of-gravity of the combined lifting tool 1 and main shaft 70 remains at the lug 50 of the lifting tool 1 with the main shaft 70 tipped enough (e.g., by 4°) in the nacelle.

With reference to FIG. 10A and FIG. 10C, having attached the main shaft lifting tool 1 to the main shaft 70 and moved the counterweight 40 to adjust the center-of-gravity of the combined lifting tool 1 and main shaft 70, the lift system 90 is operated to move the lifting tool 1 away from the nacelle 101 thereby removing the main shaft 70 from the nacelle 101. The lifting tool 1 with the dismounted main shaft 70 attached thereto can be lowered to the ground while maintaining the main shaft 70 in an inclined orientation (e.g., 4°) relative to the ground. If necessary, the position of the counterweight 40 can be adjusted on the rail 5 to pivot the combined lifting tool 1 and main shaft 70 about the pivot point at the pivot pin 52 to ensure that the main shaft 70 remains in an inclined orientation (e.g., 4°) relative to the ground.

Mounting the main shaft 70 in the nacelle 101 can be accomplished by reversing the steps described above.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A tool for lifting a main shaft of a wind turbine, the tool comprising:
a rail having a first end and a second end, the rail configured to be fixedly mounted proximate the first end of the rail to the main shaft proximate a rotor hub mounting end of the main shaft;
a counterweight movably mounted on the rail to permit moving the counterweight longitudinally along the rail; and,
a lug fixedly mounted on the rail proximate the first end of the rail, the lug configured to be securable to a lifting device so that the rail can be suspended from the lifting device.

2. The tool of claim 1, wherein the tool further comprises a carriage movably mounted on the rail to be moveable longitudinally on the rail, the counterweight secured to the carriage.

3. The tool of claim 2, wherein the carriage comprises opposed retaining plates extending beneath the rail, and between which the counterweight is secured to the carriage beneath the rail.

4. The tool of claim 3, wherein the counterweight comprises a plurality of individual slabs secured between the opposed retaining plates by at least one pin inserted through aligned apertures in the retaining plates and the slabs.

5. The tool of claim 2, wherein the tool further comprises a carriage drive configured to translate the carriage longitudinally on the rail.

6. The tool of claim 5, wherein the carriage drive comprises:
a threaded rod rotatably mounted to the rail and situated above the rail, the threaded rod extending longitudinally and parallel to the rail between the first end and the second end; and,
a bracket connected to the carriage, the bracket attached to an internally threaded guide cylinder mounted thereto through which the threaded rod is mated and rotatably mounted, the threaded rod rotatable within the guide cylinder to translate the guide cylinder and therefore the carriage longitudinally on the rail when the threaded rod rotates.

7. The tool of claim 6 further comprising a motor mount on which a motor may be mounted for operatively coupling the motor to the threaded rod for rotating the threaded rod.

8. The tool of claim 1, wherein the rail comprises an abutment plate at the first end of the rail, the abutment plate comprising at least one fastener extending longitudinally therefrom, the at least one fastener aligned with at least one flange aperture in the rotor hub flange for insertion of the at least one fastener through the at least one flange aperture to permit fixedly mounting the rail to the rotor hub flange.

9. The tool of claim 8, wherein the abutment plate comprises a face configured to abut a face of a rotor hub flange of the main shaft.

10. The tool of claim 8, wherein the at least one fastener is two fasteners and the at least one flange aperture is two flange apertures.

11. The tool of claim 8, wherein the at least one fastener is a bolt.

12. The tool of claim 8, wherein the abutment plate further comprises at least one indexing pin extending longitudinally therefrom to assist with aligning the at least one fastener with the at least one flange aperture.

13. The tool of claim 1, wherein the rail further comprises a gusset fixedly mounted on an upper surface of the rail, the lug fixedly mounted to the gusset.

14. The tool claim 1, wherein the tool comprises a pivot point at the lug where the tool is suspended from the lifting device, the counterweight comprises a center of gravity, and the counterweight is moveable proximally on the rail so that the center of gravity of the counterweight is between the first end of the rail and a vertical axis through the pivot point so that the first end of the rail can be tipped downwardly to permit connecting the rail to the main shaft when the main shaft is mounted in the wind turbine.

15. A method of dismounting a main shaft from a nacelle of a wind turbine, the method comprising:
removing a rotor hub from the main shaft;
using a lifting device to lift a counterweighted lifting tool to the main shaft;
connecting the lifting tool to the main shaft; moving a counterweight on the lifting tool to adjust a center of gravity of the connected counterweight and main shaft to a position beneath the lifting device; and,
operating the lifting device to move the lifting tool with the main shaft connected thereto to dismount the main shaft from the nacelle.

16. A method of mounting a main shaft in a nacelle of a wind turbine, the method comprising:
operating a lifting device connected to a counterweighted lifting tool, the lifting tool having the main shaft connected thereto, to move the lifting tool so that the main shaft is inserted into the nacelle;
moving a counterweight on the lifting tool to change an angle of the main shaft so that the main shaft is properly angled for mounting in the nacelle;
operating the lifting device to move the lifting tool to mount the main shaft in the nacelle; and,
disconnecting the lifting tool from the main shaft.

17. The method of claim 15, wherein the lifting device comprises a nacelle-mounted lift system.

18. The method of claim 15, wherein the counterweighted lifting tool comprises the tool of any one of claims 1 to 14.
